(19) United States
(12) Patent Application Publication
(10) Pub. No.: US 2009/0138340 A1
(43) Pub. Date: May 28, 2009

(54) METHOD, APPARATUS AND COMPUTER PROGRAM CODE FOR EVALUATING PERFORMANCE BASED ON PROJECTED RETURN AND ESTIMATED COST

(76) Inventors: Christopher A. Borr, Rohnert Park, CA (US); John Shewell, Blackwood, NJ (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/946,684

(22) Filed: Nov. 28, 2007

(51) Int. Cl. G06F 11/34

(52) U.S. Cl. 705/11

(57) ABSTRACT

A method, apparatus and computer program product are provided for assessing the overall performance of a pharmacy, or similar institution or entity, based on its current implementation of various performance measures. The method, apparatus and computer program product may further provide recommendations for performance measures on which to focus based on the current level of implementation, projected performance impact and feasibility of those performance measures. A method and apparatus are similarly provided for enabling a pharmacy, or similar institution or entity, to compare the pharmacy to other pharmacies based on user-defined parameters.

### FIELD

Embodiments of the invention relate, generally, to evaluating the performance of a pharmacy, or similar institution or entity, and, in particular, to an electronic assessment tool for evaluating the level of performance in comparison to others, as well as providing recommendations for next steps in light of the projected return and estimated cost associated with various performance options.

### BACKGROUND

Some believe that pharmacies are challenged when it comes to identifying and quantifying opportunities for improvement. While a wealth of information exists with regard to best practices, performance recommendations and improvement choices, and it is likely that a number of pharmacies have implemented some number of recommended practices, a pharmacy likely cannot implement all of the practices and improvements to their greatest extent at one time. As a result, one challenge faced by pharmacies is knowing to which practices or improvements they should devote their time and attention and in what order. Unfortunately, there is currently no concrete process for a pharmacy to apply the information available to them and translate it into actions that will result in improved clinical and financial performance. Knowing which performance recommendations to implement next to generate the best return relative to clinical and financial outcomes for the effort expended is, therefore, extremely challenging, and many pharmacies end up selecting from the available performance recommendations without any real strategic selection process and expending resources on less than efficient performance improvement efforts that yield suboptimal results compared to what they have accomplished. A need, therefore, exists for a tool that a pharmacy can use for identifying, planning and implementing optimal practice or performance measures.

In evaluating a pharmacy's overall performance, it may also be beneficial to be able to compare the pharmacy with other pharmacies to determine how it is performing relative to its peers. Benchmarking (i.e., comparing performance metrics) with others is a common practice within the healthcare industry. Healthcare benchmark solutions available today, however, are built from a consolidated facility's point of view. In other words, the benchmark solutions available today compare all departments of a facility against other facilities with similar demographic profiles (e.g., number of beds, geographic location, case mix severity, etc.). While this comparison is useful at a facility macro-view, it becomes significantly less relevant at the department level, particularly with regard to pharmacies. Using this consolidated facility model, pharmacies are constantly being compared to other facility pharmacies that may or may not be relevant because of their significantly disparate profiles. For example, one hospital having a centralized pharmacy may have a similar profile to another hospital having a decentralized pharmacy. A comparison of a centralized pharmacy to a decentralized pharmacy may not be very relevant or productive. As a result, pharmacies are commonly forced to justify their current activities compared to another, dissimilar, facility's pharmacy. A need, therefore, exists for a benchmarking system that enables a pharmacy to be compared to pharmacies selected because of parameters specific to the pharmacies themselves, and not the likeness of the facilities within which the pharmacies operate.

### BRIEF SUMMARY

In general, embodiments of the present invention provide an improvement by, among other things, providing an enhanced tool for assessing the overall performance of a pharmacy, or similar institution or entity, based on its current implementation of various performance measures. The tool of one embodiment may provide recommendations for performance measures on which to focus based on the current level of implementation, as well as the projected performance impact and feasibility of those performance measures. According to another embodiment, a benchmarking tool is further provided for comparing a pharmacy, or similar institution or entity, to other pharmacies, or similar entities, based on user-defined parameters.

In accordance with one aspect, a method is provided of evaluating an institute's (e.g., pharmacy's or similar entity's) performance. In one embodiment, the method may include: (1) receiving a definition of a set of performance measures; (2) assigning a performance impact parameter to respective performance measures, wherein the performance impact parameter is based at least in part on a projected return associated with implementation of the performance measure; (3) receiving an indication of a current level of implementation associated with respective performance measures; and (4) evaluating an overall performance based at least in part on the current level of implementation and the performance impact parameter associated with respective performance measures.

In accordance with another aspect, an apparatus is provided for evaluating an institute's performance. In one embodiment, the apparatus may include a processor configured to: (1) receive a definition of a set of performance measures; (2) assign a performance impact parameter to respective performance measures, wherein the performance impact parameter is based at least in part on a projected return associated with implementation of the performance measure; (3) receive an indication of a current level of implementation associated with respective performance measures; and (4) evaluate an overall performance based at least in part on the current level of implementation and the performance impact parameter associated with respective performance measures.

In accordance with yet another aspect, a computer program product is provided for evaluating an institute's performance. The computer program product contains at least one computer-readable storage medium having computer-readable program code portions stored therein. The computer-readable program code portions of one embodiment include: (1) a first executable portion for receiving a definition of a set of performance measures; (2) a second executable portion for assigning a performance impact parameter to respective performance measures, wherein the performance impact parameter is based at least in part on a projected return associated with implementation of the performance measure; (3) a third executable portion for receiving an indication of a current level of implementation associated with respective performance measures; and (4) a fourth executable portion for evaluating an overall performance based at least in part on the current level of implementation and the performance impact parameter associated with respective performance measures.

According to yet another aspect, a method is provided for benchmarking an institution. In one embodiment, the method may include: (1) receiving a value for at least two of a plurality of parameters associated with a first entity; (2) receiving an indication of one or more of the plurality of parameters to be used in creating a group of one or more entities with which to compare the first entity; and (3) assembling the group of one or more entities by identifying one or more entities having a value for respective one or more indicated parameters that is different than the value received from the first entity in association with the respective one or more indicated parameters and a value for a remaining one or more of the plurality of parameters not indicated that is the same as the value received from the first entity in association with the respective one or more remaining parameters.

According to another aspect, an apparatus is provided for benchmarking an institution. In one embodiment the apparatus may include a processor that is configured to: (1) receive a value for at least two of a plurality of parameters associated with a first entity; (2) receive an indication of one or more of the plurality of parameters to be used in creating a group of one or more entities with which to compare the first entity; and (3) assemble the group of one or more entities by identifying one or more entities having a value for respective one or more indicated parameters that is different than the value received from the first entity in association with the respective one or more indicated parameters and a value for a remaining one or more of the plurality of parameters not indicated that is the same as the value received from the first entity in association with the respective one or more remaining parameters.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1A is a block diagram of one type of system that would benefit from embodiments of the present invention;

FIG. 1B is a schematic block diagram of an entity capable of operating as an assessment server in accordance with embodiments of the present invention;

FIG. 2 is a flow chart illustrating the operations that may be performed by the assessment tool of embodiments of the present invention;

FIGS. 3A-3C are screen shots from the High Performance Pharmacy^{SM} Web Site at www.highperformancepharmacy.com providing performance measures, performance impact parameters and feasibility parameters that may be used in an embodiment of the present invention when evaluating a pharmacy;

FIGS. 4A-4B illustrate data that may be gathered and parameters that may be derived by the assessment tool of embodiments of the present invention prior to receiving any input from a pharmacy desiring to be evaluated;

FIG. 5 illustrates data that may be obtained by the assessment tool of embodiments of the present invention from the pharmacy and parameters that may be derived based on the data provided;

FIGS. 6-7B represent different assessment or evaluation outputs that may be provided in accordance with embodiments of the present invention;

FIGS. 8A-8D illustrate data that may be used and parameters that may be derived in accordance with embodiments of the present invention in order to provide a pharmacy with a recommendation for performance measures to be further implemented;

FIG. 8E represents a recommendation that may be provided to a pharmacy in accordance with an embodiment of the invention; and

FIG. 9 is a flow chart illustrating the operations that may be performed by a benchmarking tool of embodiments of the present invention.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overview:

In general, embodiments of the present invention provide a method, apparatus and computer program product for assessing the performance of a pharmacy, or similar institution or entity, both in terms of on what areas the pharmacy should be focusing in order to obtain the most benefit for the least cost, and in relation to the performance of other pharmacies, or similar institutions or entities. In particular, according to one embodiment, a plurality of performance measures may be defined for assessing a pharmacy based on the pharmacy's implementation of those performance measures. Because the implementation of different performance measures may result in different degrees of improvement to the clinical and/or financial performance of the pharmacy, in evaluating the pharmacy based on its implementation of the performance measures, each of the performance measures may be weighted based on their projected return or performance impact. For example, a pharmacy's current level of implementation of a performance measure having a low projected impact on the pharmacy's clinical and/or financial performance may not be valued as highly as the pharmacy's current level of implementation of a performance measure having a high projected impact on the pharmacy's clinical and/or financial performance.

According to one embodiment, a recommendation of one or more performance measures on which to focus additional time and effort in order to increase the level of implementation may further be provided to the pharmacy, or similar institution or entity. This recommendation may include the performance measures having the greatest opportunity for return in light of the pharmacy's, or similar institution's, current level of implementation. In particular, one or more performance measures may be selected based on the projected financial and/or quality/safety return or performance impact associated with an increase in implementation of those performance measures. In addition, according to one embodiment, the feasibility or cost associated with each of the performance measures may also be taken into consideration when generating a recommendation. In this embodiment, the recommendation may include performance measures that are projected to provide the greatest benefit or return for the least cost or inconvenience.

In addition to the foregoing, according to another embodiment, a benchmarking tool may be provided that enables the pharmacy, or other similar institution or entity, to determine with which other pharmacies, or similar institutions, it would like to be compared based on a number of common, or uncommon, factors or parameters. Using this benchmarking tool, the pharmacy can see the direct effects of implementation, or non-implementation, of one or more specific factors by comparing itself with other pharmacies, or similar institutions, having all but that factor(s) in common. This tool provides yet another technique for evaluating the performance of the pharmacy, or similar institution or entity.

### Overall System and Apparatus:

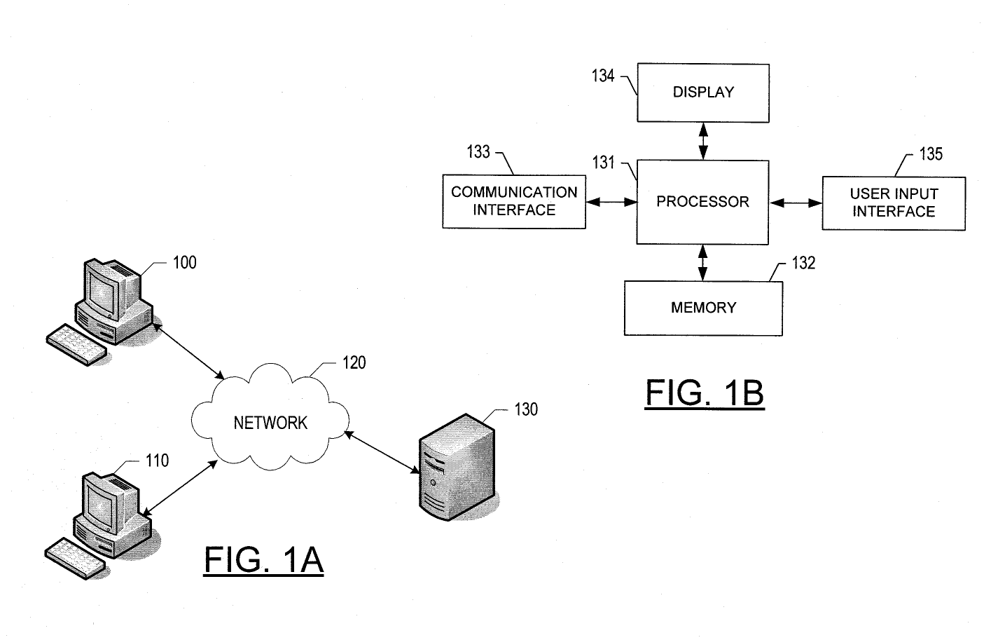

Referring to FIG. 1A, an illustration of one type of system that would benefit from embodiments of the present invention is provided. As shown, the system may include one or more electronic devices 100, 110 (e.g., personal computers (PCs), laptops, personal digital assistants (PDAs), etc.) operated by the personnel of a pharmacy, or similar institution, in order to access an assessment server 130, or similar network entity, over a network 120, such as a wired or wireless local area network (LAN), a metropolitan area network (MAN), and/or a wide area network (WAN) (e.g., the Internet).

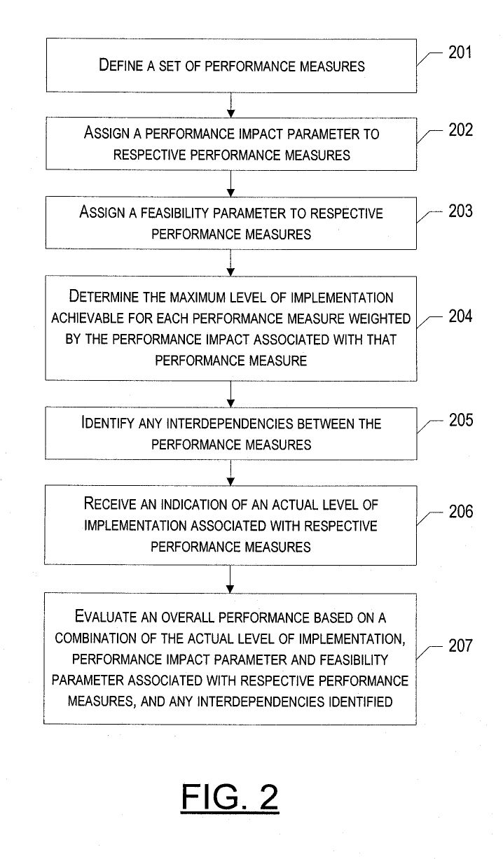

The assessment server 130, or similar network entity, which is shown in more detail in FIG. 1B, may include various means for performing one or more functions in accordance with embodiments of the present invention, including those more particularly shown and described herein. It should be understood, however, that the assessment server 130 may include alternative means for performing one or more like functions, without departing from the spirit and scope of the present invention. As shown, the assessment server 130 can generally include means, such as a processor 131, for performing or controlling the various functions of the entity. In particular, as is discussed in more detail below with regard to FIGS. 2 though 8E, according to one embodiment, the processor may be configured to define (or receive a definition of) a set of performance measures for evaluating a pharmacy, or similar institution or entity, and to assign a performance impact parameter to each of the performance measures, wherein the performance impact parameter is based on the projected return (e.g., financial and/or quality or safety return) associated with implementation of the performance measure. The processor may be further configured to receive an indication of a pharmacy's, or similar institution's, current level of implementation of each of the performance measures, and to evaluate an overall performance of the pharmacy, or similar institution, based on the current level of implementation and the performance impact parameter associated with each performance measure.

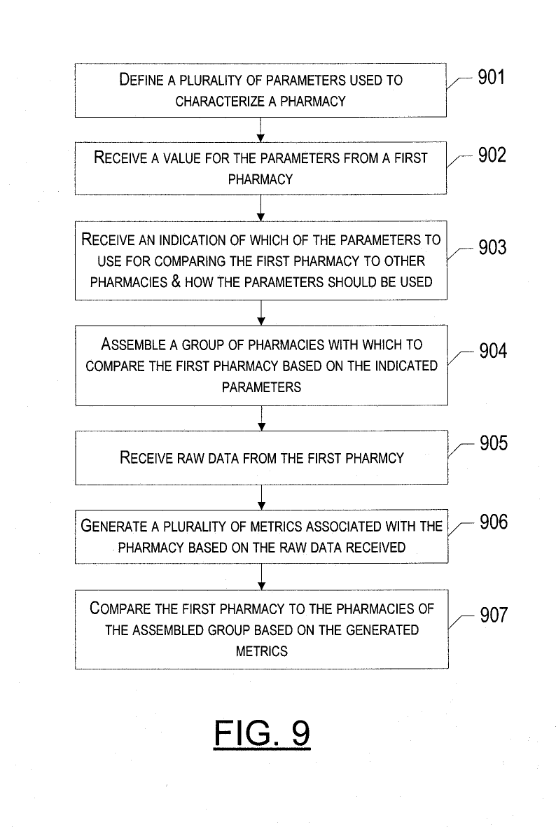

According to another embodiment, and as is also discussed in more detail below with regard to FIG. 9, the processor may further be configured to receive a value for at least two of a plurality of parameters associated with a pharmacy (referred to as “the requesting pharmacy”), or similar entity. The processor of this embodiment may be configured to receive an indication of which of the plurality of parameters should be used to create a group of additional pharmacies, or similar entities, with which to compare the requesting pharmacy. The processor may be configured to then assemble the group based on the parameter(s) indicated by identifying one or more entities having a value for respective one or more indicated parameters that is different than the value received from the requesting pharmacy, as well as a value for the remaining one or more of the plurality of parameters not indicated that is the same as the value received from the requesting pharmacy.

While the foregoing assumes that the benchmarking analysis of embodiments of the present invention, described in relation to FIG. 9, is implemented by the same server (i.e., the assessment server 130) and, therefore, the same processor 131, as the evaluation process described herein with regard to FIGS. 2 through 8E, as one of ordinary skill in the art will recognize, the benchmarking analysis may alternatively be performed by a separate server and corresponding processor. Embodiments of the invention are, therefore, not limited to use of one server and corresponding processor for implementation of both the evaluation and benchmarking processes described herein.

In one embodiment, the processor is in communication with or includes memory 132, such as volatile and/or non-volatile memory that stores content, data or the like. For example, the memory 132 typically stores content transmitted from, and/or received by, the entity. Also for example, the memory 132 typically stores software applications, instructions or the like for the processor to perform steps associated with operation of the entity in accordance with embodiments of the present invention. In particular, the memory 132 may store computer program code, instructions or the like for the processor to perform the steps described above and below with regard to FIGS. 2 and 9.

In addition to the memory 132, the processor 131 can also be connected to at least one interface or other means for displaying, transmitting and/or receiving data, content or the like. In this regard, the interface(s) can include at least one communication interface 133 or other means for transmitting and/or receiving data, content or the like, as well as at least one user interface that can include a display 134 and/or a user input interface 135. The user input interface, in turn, can comprise any of a number of devices allowing the entity to receive data from a user, such as a keypad, a touch display, a joystick or other input device.

### Assessment Method:

Reference is now made to FIGS. 2 through 8E, which illustrate the operations that may be taken in order to evaluate a pharmacy based on the pharmacy's current implementation of various performance measures (e.g., structures, policies, procedures, activities and practices). As one of ordinary skill in the art will recognize, embodiments of the present invention are not limited to use with regard to pharmacies and, instead, may similarly be applied in other industries where performance measures can be established and evaluated based on their current level of implementation and the projected return versus cost associated therewith. In addition, while the following description provides one example of performance measures that could be used and the specific manner in which they are used, as one of ordinary skill in the art will recognize, other performance measures may be similarly used in a similar manner in order to evaluate a pharmacy without departing from the spirit and scope of embodiments of the present invention.

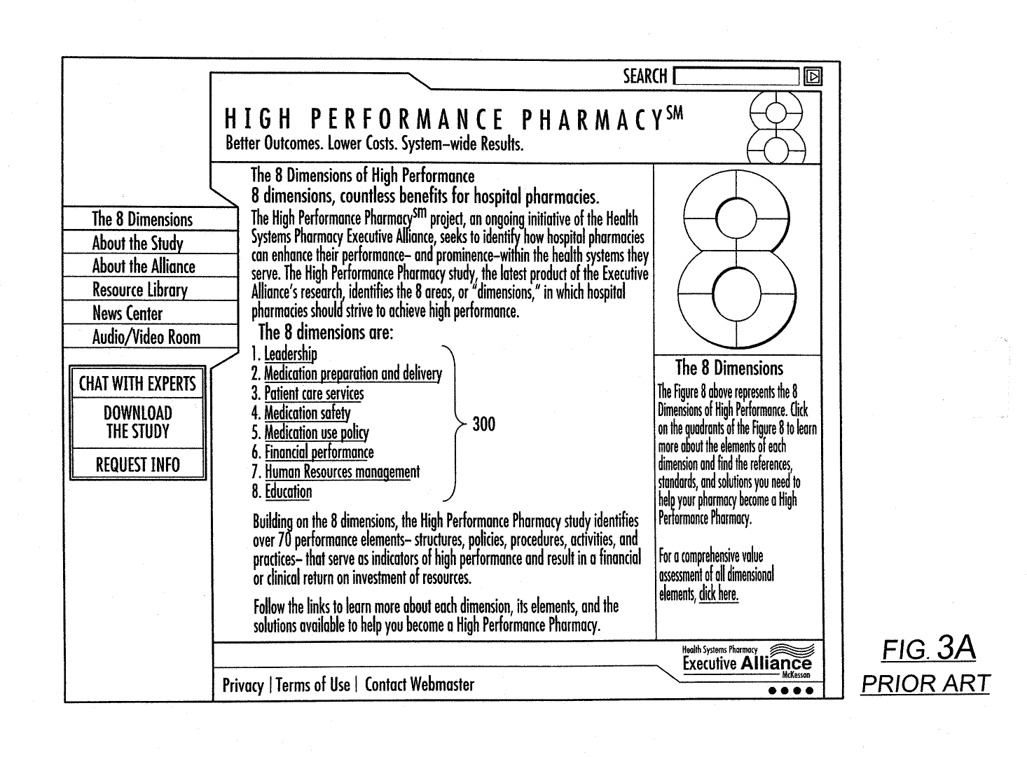

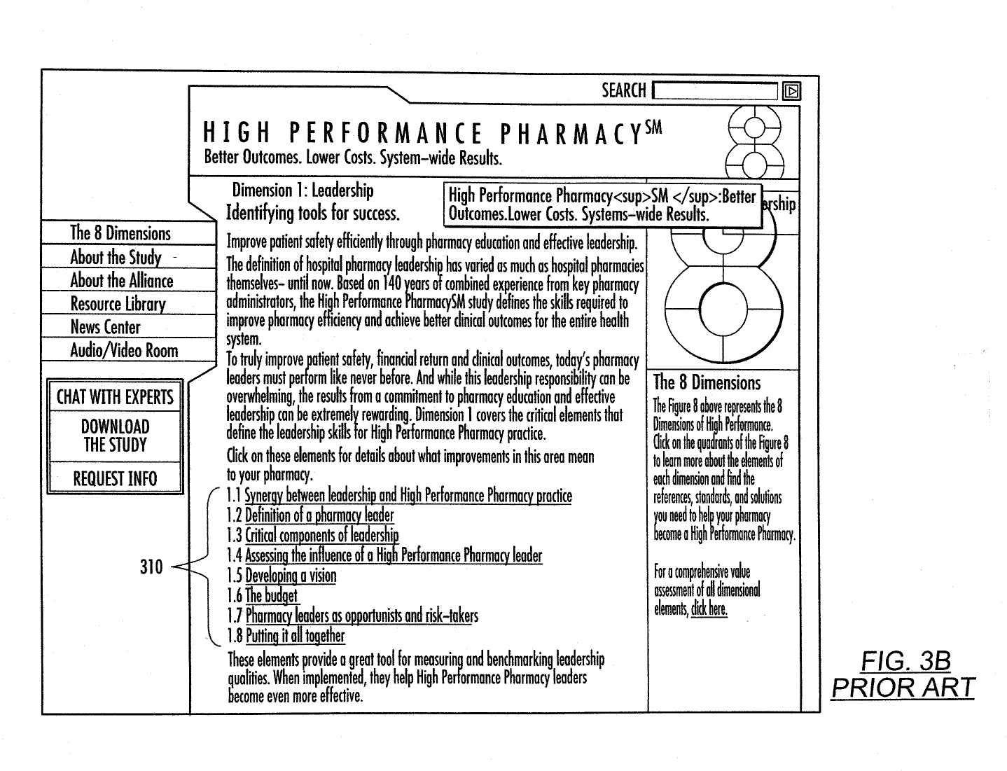

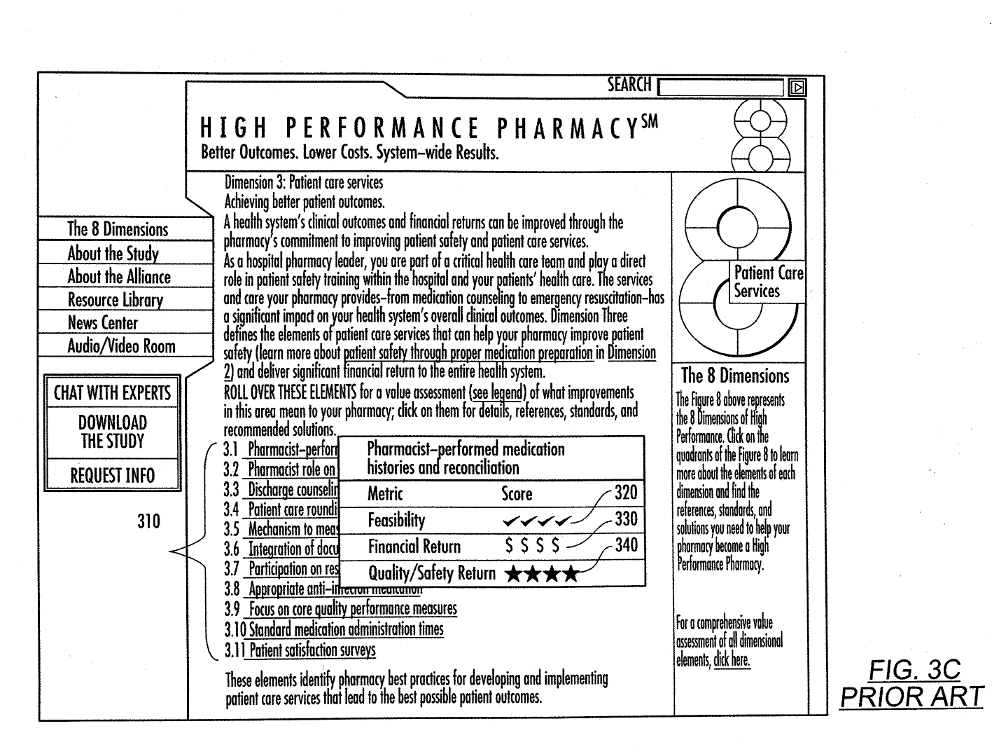

As shown in FIG. 2, the process may begin at Block 201 when the assessment server and, in particular, a processor or similar means operating on the assessment server defines a set of performance measures for evaluating a pharmacy. In one embodiment, these performance measures may correspond to the “proven best practices” identified by the High Performance Pharmacy^{SM} project, an ongoing initiative of the Health Systems Pharmacy Executive Alliance (hereinafter “the Alliance”) and McKesson Corporation (hereinafter “McKesson”), with all intellectual property rights relating to all published and unpublished High Performance Pharmacy^{SM} work product owned by McKesson, such that defining the set of performance measures comprises obtaining the performance measures from the High Performance Pharmacy^{SM} project. In connection with the High Performance Pharmacy^{SM} project, the Alliance and McKesson conducted a study which identified proven best practices for achieving high performance across eight areas or “dimensions” (i.e., subsets of the set of performance measures). As shown in FIG. 3A, which is a screen shot from the High Performance Pharmacy^{SM} Web Site at www.highperformancepharmacy.com/8dimensions.php, these dimensions 300 include: (1) leadership; (2) medication preparation and delivery; (3) patient care services; (4) medication safety; (5) medication use policy; (6) financial performance; (7) human resources management; and (8) education.

In building these areas or dimensions, the High Performance Pharmacy^{SM} study identified over 70 performance elements (e.g., structures, policies, procedures, activities and practices) falling within these areas or dimensions that serve as indicators of high performance and result in a financial or clinical return on investment of resources. For example, as shown in FIG. 3B, which is another screen shot from the High Performance Pharmacy^{SM} Web Site at www.highperformancepharmacy.com/8dimensions-leadership.php, the elements 310 falling under the first dimension, leadership, include: (1) synergy between leadership and High Performance Pharmacy practice; (2) definitions of a pharmacy leader; (3) critical components of leadership; (4) assessing the influence of a High Performance leader; (5) developing a vision; (6) the budget; (7) pharmacy leaders as opportunists and risk takers; and (8) putting it all together. According to the High Performance Pharmacy^{SM} study, these elements or performance measures 310 provide a tool for measuring and benchmarking the leadership qualities of a pharmacy. Additional elements (or performance measures) 310 have been identified for each of the remaining areas or dimensions (or subsets of performance measures) 300 and can similarly be used to measure and benchmark a pharmacy's performance in the corresponding area or dimension.

Once the performance measures have been defined, the assessment server and, in particular a processor or similar means operating on the assessment server may assign one or more performance impact parameters, as well as a feasibility parameter, to each performance measure. (Blocks 202 and 203). In particular, each performance measure may be evaluated to determine a projected benefit that would be derived from implementing the performance measure. This benefit may be in terms of an expected financial return associated with implementation of the performance measure and/or an estimate of the improvements in the quality or safety of the pharmacy that may be seen as a result of implementation of the performance measures. A value associated with either or both of these parameters may thereafter be assigned to each performance measure as performance impact parameters. In contrast, the feasibility parameter may correspond to an estimate of the cost, for example, in terms of money, time and/or personnel, associated with implementation of the performance measure.

In one embodiment, the performance impact and feasibility parameters for each performance measure may be defined by the High Performance Pharmacy^{SM} project, such that assigning a performance impact and feasibility parameter comprise obtaining these parameters from the High Performance Pharmacy^{SM} project. For example, as shown in FIG. 3C, which is a screen shot from the High Performance Pharmacy^{SM} Web Site at www.highperformancepharmacy.com/8dimensions-patient_care_services.php, each element or performance measure may be assigned a Feasibility parameter (indicated by the number of check marks) 320, Financial Return parameter (indicated by the number of dollar signs) 330, and Quality/Safety Return parameter (indicated by the number of stars) 340. The Financial Return parameter provides an estimate of the level of financial return on investment (ROI) associated with implementing an element. In one implementation developed by the High Performance Pharmacy™ project that is described by way of example but not of limitation, the Financial Return assigned to an element may take the value of zero to four, where zero represents minimal ROI or cost-neutral; one represents a ROI that is less than or equal to 20% of the amount invested; two represents a ROI that is between 26 and 50% of the amount invested; three represents a ROI that is between 51 and 100% of the amount invested; and five represents a ROI that is greater than 100% of the amount invested.

In this example of an implementation developed by High Performance Pharmacy™ project, the Quality/Safety Return parameter represents an estimate of the quality and safety benefits resulting from implementing an element. This parameter can likewise take the value of zero to four, where zero indicates that the element yields no measurable improvement; one indicates that the element will improve the quality and safety slightly, but improvements may be too small to measure; two represents small improvement; three represents moderate improvement; and four represents a substantial improvement in the quality and safety of the pharmacy resulting from implementation of the element, which should be considered a best practice. Finally, the Feasibility parameter in this example of an implementation developed by the High Performance Pharmacy™ project estimates the complexity and level of effort required to implement an element. The feasibility parameter may take the value of one to four, where one represents a very simple implementation that seldom (if ever) requires financial investment or additional staff, two represents a simple implementation requiring a labor investment of 0.5 full-time equivalents (FTEs) and/or a minor amount of other direct expenses; three represents a moderately complex implementation requiring a labor investment of between 0.5 and one FTE and/or a moderate amount of other direct expenses; and four represents a complex implementation requiring a labor investment of more than one FTE and/or a substantial amount of other direct expenses. It is noted, however, that other types of performance impact parameters and other definitions of the foregoing performance impact parameters may be employed in other embodiments.

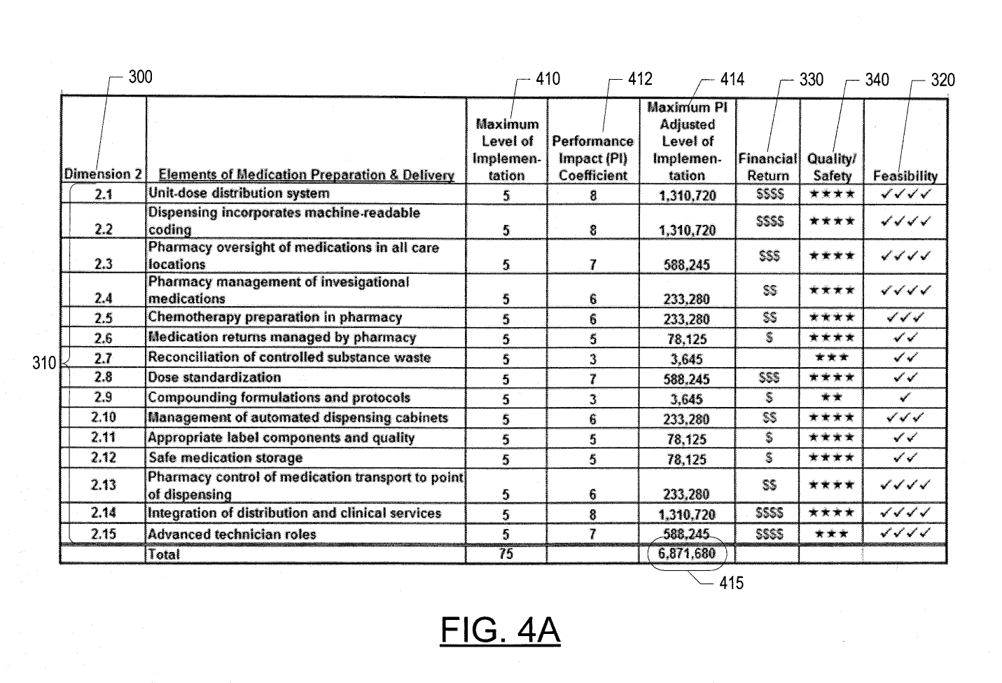

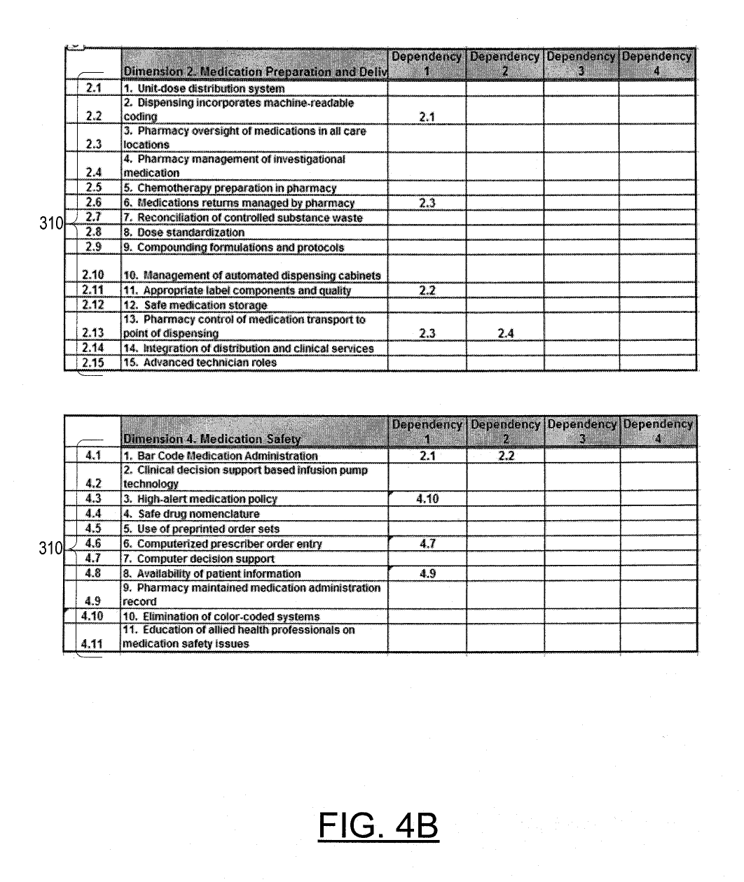

Returning to FIG. 2, according to one embodiment, using the performance impact parameters assigned to each performance measure, the assessment server (e.g., a processor or similar means operating on the assessment server) may determine a Maximum Level of Implementation that is associated with each performance measure and is weighted or scaled based on the projected performance impact of that performance measure (i.e., a Maximum Performance Impact Adjusted Level of Implementation). (Block 204). Because the Maximum Performance Impact Adjusted Level of Implementation takes into consideration the projected returns, financial and other, associated with implementing the various performance measures, it provides a better indication of the effect of implementing the performance measure. As a result, this parameter can be used in evaluating a pharmacy's performance based on its current level of implementation of each performance measure. As illustrated in FIG. 4A, in one embodiment, the Maximum Performance Impact Adjusted Level of Implementation 414 associated with each performance measure may be determined by first calculating the Performance Impact Coefficient 412 associated with each element or performance measure, which according to one embodiment, may be equal to the sum of the performance impact parameters assigned at Block 202. For example, the Performance Impact Coefficient 412 may be equal to the sum of the Financial Return parameter 330 and the Quality/Safety Return parameter 340 assigned to the performance measure or element by the High Performance Pharmacy^{SM} project. To illustrate, the Performance Impact Coefficient 412 associated with the element 2.3 (i.e., pharmacy oversight of medication in all care locations) may be equal to seven, or the sum of the Financial Return parameter 330 associated with element 2.3 (i.e., 3) and the Quality/Safety Return parameter 340 associated with element 2.3 (i.e., 4). The Maximum Performance Impact Adjusted Level of Implementation for each performance measure may then be calculated by multiplying the Maximum Level of Implementation associated with the performance measure or element 410 (e.g., 5) by the Performance Impact Coefficient 412 of that performance measure or element raised to a predefined power, such as the power of six as indicated in the following mathematical representation of the foregoing example:

Maximum PI Adjusted Level of Implementation=(Maximum Level of Implementation*(PI Coefficient)⁶)

The predefined power may be used to scale the product of the Maximum Level of Implementation when multiplied by the Performance Impact Coefficient. Under this approach, the resulting product of a practice that yields higher clinical/safety return and financial return will be significantly greater than the resulting product for a practice with lower clinical/safety and financial returns, even if both had the same level of implementation. In other words, the difference in the two practices based on the clinical/safety and financial return may be more pronounced. This scaling may allow for the relative value of the various practices to be compared, and the comparison may identify those practices that have relatively greater weight or value relative to clinical/safety and financial return.

Continuing with the example above, using the above formula, the Maximum Performance Impact Adjusted Level of Implementation associated with element 2.3 is 588,245, based on a Maximum Level of Implementation 410 of five and a Performance Impact Coefficient of seven (i.e., 5*7⁶). As noted above, by raising the Performance Impact Coefficient 412 by the power of six, emphasis can be placed on the financial and quality/safety return associated with each performance measure in order to more clearly differentiate between performance measures having a high projected financial and/or quality/safety return from those having a lower projected financial and/or quality/safety return.

Once the Maximum Performance Impact Adjusted Level of Implementation 414 has been calculated for each of the elements 310 of a dimension 300 (i.e., for each performance measure in the subset of performance measures), according to one embodiment, the overall Maximum Performance Impact Adjusted Level of Implementation associated with the area or dimension 415 may be calculated by summing the Maximum Performance Impact Adjusted Level of Implementation 414 of each element 300. This parameter can also be used in evaluating a pharmacy's overall performance within the area or dimension.

As one of ordinary skill in the art will recognize, the performance measures that can be implemented by a pharmacy do not operate in a vacuum. As a result, in order to implement certain performance measures, or to incur the most benefit from implementing those performance measures, it may be beneficial, if not necessary, to previously and/or simultaneously implement other performance measures. It is these interdependent performance measures that the assessment server (e.g., a processor similar means operating on the assessment server) may identify at Block 205. For example, referring to FIG. 4B, elements 2.3 (e.g., pharmacy oversight of medication in all care locations) and 2.4 (e.g., pharmacy management of investigational medication) may be interdependent on element 2.13 (i.e., pharmacy control of medication transport to point of dispensing), meaning that in order to implement element 2.13 it may be beneficial, if not necessary, to also implement elements 2.3 and 2.4, and vice versa.

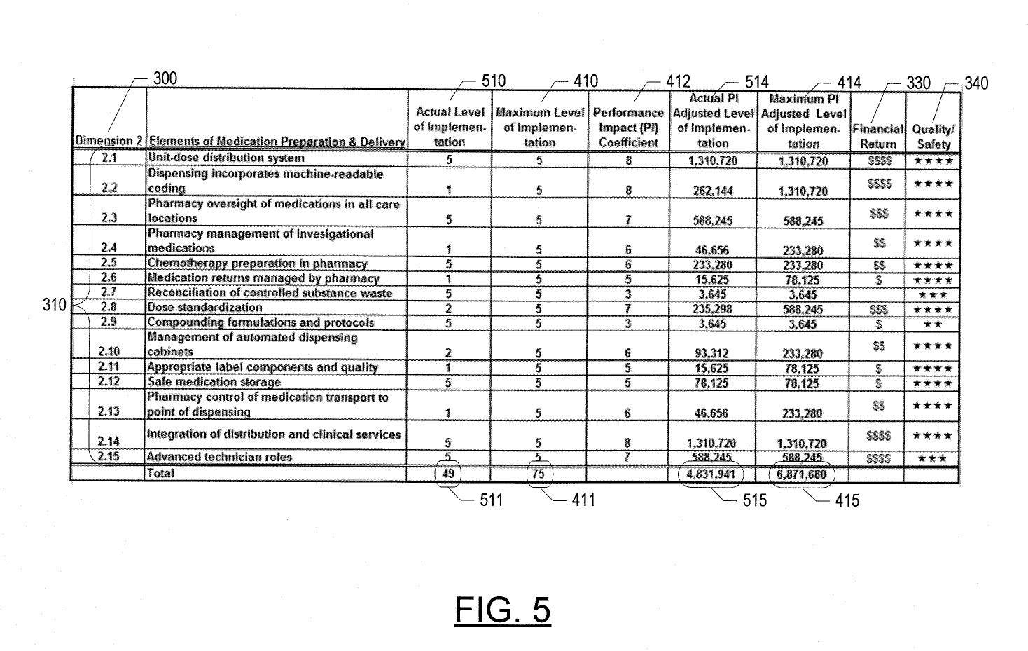

At this point, the assessment server, and in particular a processor or similar means operating on the assessment server may be ready to receive input from a pharmacy desiring an assessment (e.g., from an electronic device 100, 110 operated by pharmacy personnel and via a network 120, such as the Internet). In particular, in one embodiment, the assessment server (e.g., the processor or similar means operating on the processor) may receive, at Block 206, an indication of the pharmacy's Actual Level of Implementation associated with respective performance measures. For example, according to one embodiment shown in FIG. 5, pharmacy personnel may input the Actual Level of Implementation 510, such as on a scale of one to five, of each of the elements 310 associated with a particular High Performance Pharmacy^{SM} dimension. In this embodiment, a value of one may indicate that the pharmacy never practices a particular element of the dimension, two may indicate that the pharmacy rarely practices it (e.g., 1-25% of the time), three that the pharmacy sometimes practices it (e.g., 26-50% of the time), four that the pharmacy usually practices it (e.g., 51-75% of the time), and five that the pharmacy almost always practices it (e.g., 76-100% of the time).

The assessment server (e.g., the processor or similar means operating on the assessment server) can then use this information, at Block 207, along with all of the information discussed above (e.g., the performance impact and feasibility parameters assigned to each performance measure, the Maximum Performance Impact Adjusted Level of Implementation, and any interdependencies identified between the performance measures) to evaluate an overall performance of the pharmacy. In particular, as is discussed in more detail below with regard to FIGS. 5 through 8E, the assessment server may not only evaluate the strengths of the pharmacy by identifying the performance measures on which the pharmacy is using its resources productively or for the greatest expected return, but may also provide a recommendation including a prioritized list of one or more performance measures on which to use additional resources in order to see the greatest performance impact per dollar of cost.

For example, according to one embodiment wherein the High Performance Pharmacy^{SM} dimensions (or subsets of performance measures) and corresponding elements (or performance measures) are used in evaluating the pharmacy, once the assessment server (e.g., the processor or similar means operating on the assessment server) has received an indication of the Actual Level of Implementation 510 associated with each element 310 of a dimension, the assessment server (e.g., processor or similar means) of one embodiment may calculate the Actual Performance Impact Adjusted Level of Implementation 412 associated with each element by multiplying the Actual Level of Implementation 510 associated with the element by the Performance Impact Coefficient 412 associated with that element raised to the power of six:

Actual PI Adjusted Level of Implementation=(Actual Level of Implementation*(PI Coefficient)⁶)

As discussed above with regard to the Maximum Performance Impact Adjusted Level of Implementation 414, by weighing the Actual Level of Implementation 510 by the Performance Impact Coefficient 412, which represents a combination of the Financial Return and the Quality/Safety Return associated with implementation of the element and which is raised to a specific power based upon the relative priority to be afforded to the Performance Impact Coefficient relative to the Actual Level of Implementation, the practical or real-life value associated with the implementation of the various elements can be more easily, and more concretely, identified. For example, as shown in FIG. 5, the Actual Level of Implementation of element 2.2 (i.e., dispensing incorporates machine-readable coding) is less than the Actual Level of Implementation of both elements 2.8 (i.e., dose standardization) and 2.10 (i.e., management of automated dispensing). However, because of the relative impact on the pharmacy in terms of a projected financial return and quality/safety return, the weighted value associated with implementation of element 2.2 is greater than that of elements 2.8 and 2.10. In other words, the Actual Performance Impact Adjusted Level of Implementation associated with element 2.2 (i.e., 262,144) is higher than that of both 2.8 (i.e., 235,298) and 2.10 (93,212), indicating that the financial and quality/safety return seen based on the level of implementation of element 2.2 is higher than that of 2.8 and 2.10, despite the fact that each of those elements are implemented more frequently and/or to a greater extent.

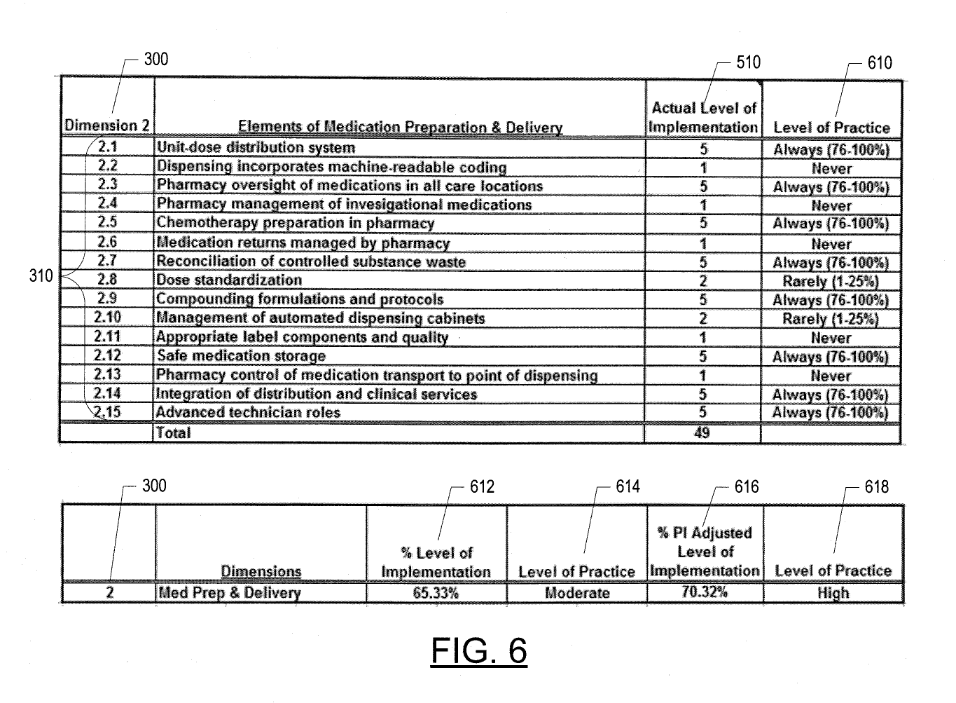

Using the information above, the assessment server (e.g., processor or similar means operating on the assessment server) may display, for the pharmacy, evaluation or assessment results associated with the particular dimension or area (i.e., subset of performance measures). FIG. 6 provides an example of what may be displayed according to one embodiment of the present invention. As shown, the display may include the Actual Level of Implementation 510 input by the pharmacy in association with each element, as well as the corresponding Level of Practice 610 associated with each element. In one embodiment, the Level of Practice may be selected from the following: Never, Rarely (1-25%), Sometimes (26-50%), Usually (51-75%), and Always (76-100%). The assessment server (e.g., processor or similar means) may further display the % Level of Implementation 612 and corresponding Level of Practice 614 associated with the dimension, as well as the % Performance Impact Adjusted Level of Implementation 616 and corresponding Level of Practice 618, wherein:

% Level of Implementation=Actual Level of Implementation/Maximum Level of Implementation; and

% PI Adjusted Level of Implementation=Actual PI Adjusted Level of Implementation/Maximum PI Adjusted Level of Implementation

According to one embodiment, the Level of Practice 614, 618 may be selected based on the % Level of Implementation 612 and % Performance Impact Adjusted Level of Implementation 616, respectively, wherein the Level of Practice is Low if the percentage is less than or equal to 50%, Moderate if it is between 50 and 70%, and High if it is equal to or greater than 70%. If, as is shown in FIG. 6, the % Actual Level of Implementation is less than the % Performance Impact Adjusted Level of Implementation, then this may indicate that the pharmacy is focusing on areas or elements having a greater financial and/or quality/safety return. Alternatively, if the % Actual Level of Implementation is higher, then this may indicate that the pharmacy is focusing on elements having a lower performance impact (e.g., financial return and/or quality/safety return) associated therewith.

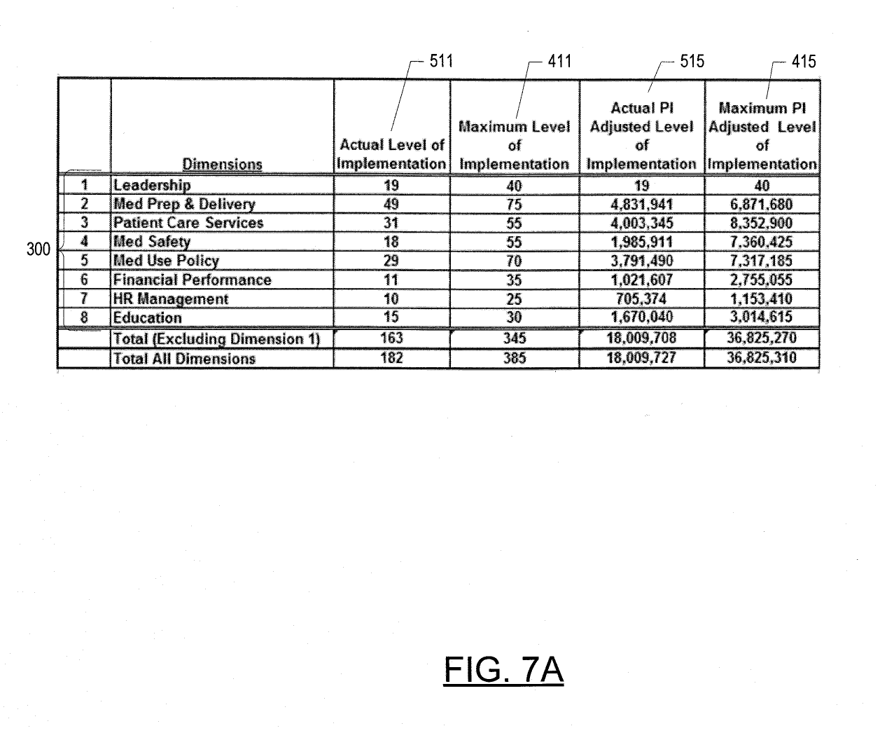

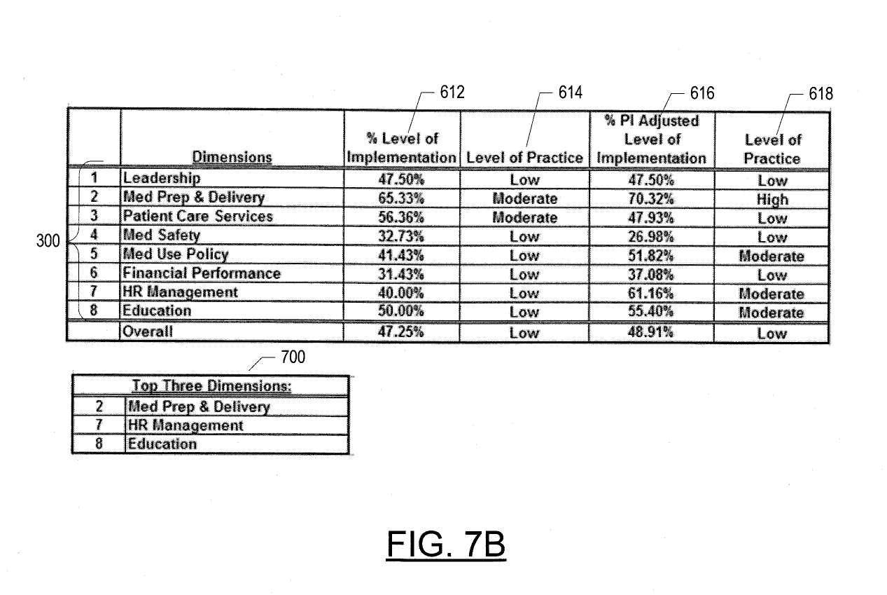

Once the pharmacy has input, and the assessment server (e.g., processor or similar means) has received, the Actual Level of Implementation 510 associated with each element 310 (or performance measure) of each area or dimension 300 (or subset of performance measures), the assessment server (e.g., processor or similar means) of one embodiment may provide an overall assessment of the pharmacy in terms of each dimension. An example of this assessment is provided in FIGS. 7A and 7B. In particular, according to one embodiment, the assessment server (e.g., processor or similar means) may first determine the Actual Level of Implementation 511 and the Actual Performance Impact Adjusted Level of Implementation 515 associated with each dimension by summing the Actual Level of Implementation 510 associated with each element of the dimension, and the Actual Performance Impact Adjusted Level of Implementation 514 associated with each element of the dimension, respectively. FIG. 7A illustrates an example of how the results of these calculations may be displayed to the user.

Referring to FIG. 7B, the assessment server, and, in particular, a processor or similar means operating on the assessment server of one embodiment, may further display the % Level of Implementation 612 and corresponding Level of Practice 614, as well as the % Performance Impact Adjusted Level of Implementation 616 and corresponding Level of Practice 618 (e.g., calculated in the manner described above with respect to FIG. 5), for each dimension. Finally, the assessment server (e.g., processor or similar means) may then select and display the top three dimensions or areas of performance by the pharmacy 700 in light of the pharmacy's implementation of the elements within those dimensions and the performance impact associated with the implementation. For example, in the illustrated example shown in FIG. 7B, the % Performance Impact Adjusted Level of Implementation 616 associated with dimension 2 (i.e., medication preparation and delivery) is the highest, with a value of 70.32%, indicating that, given the projected financial and quality/safety return associated with dimension 2, the pharmacy is implementing this dimension to the greatest degree relative to the other dimensions. Similarly, dimensions 7 (i.e., HR management) and 8 (i.e., education), having % Performance Impact Adjusted Levels of Implementation of 61.16% and 55.40%, respectively, are the second and third top dimensions or areas in which the pharmacy is implementing elements resulting in more significant prospects for financial and quality/safety return. By identifying these top dimensions or areas to the pharmacy, the assessment server is indicating to the pharmacy the areas or dimensions in which the pharmacy is most efficiently using its resources.

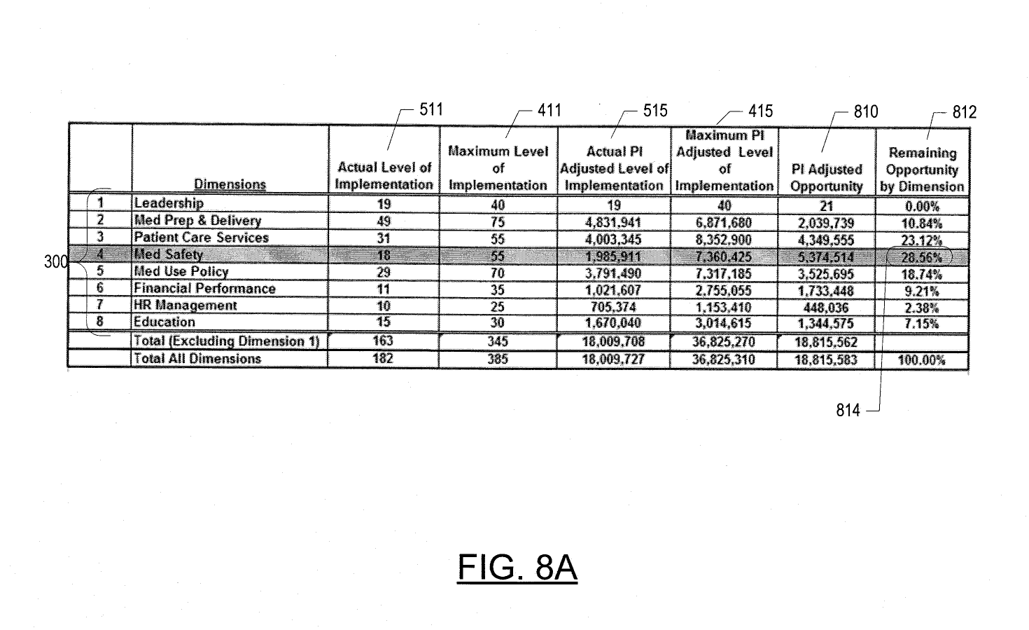

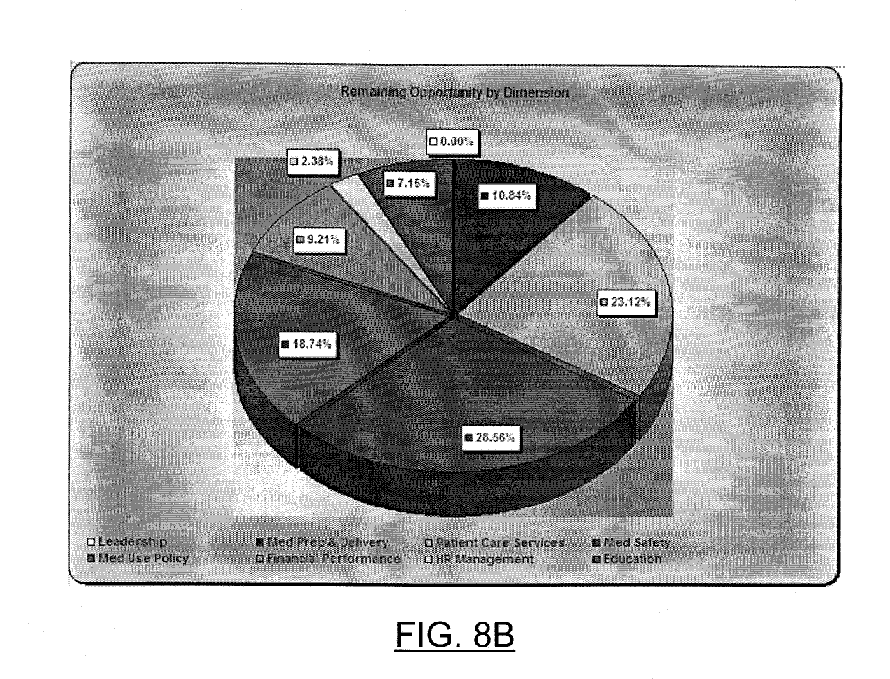

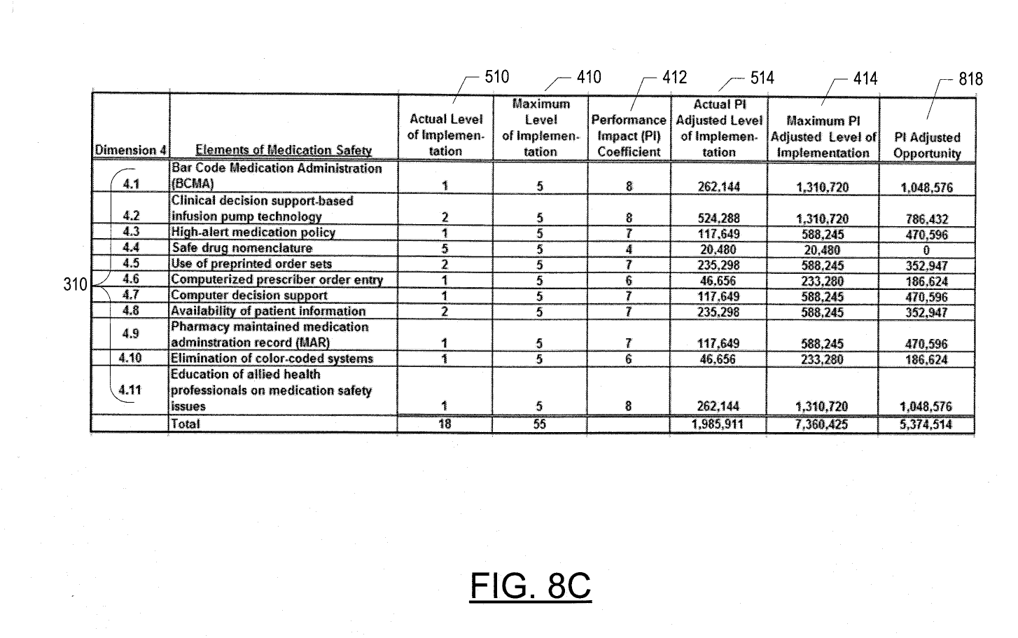

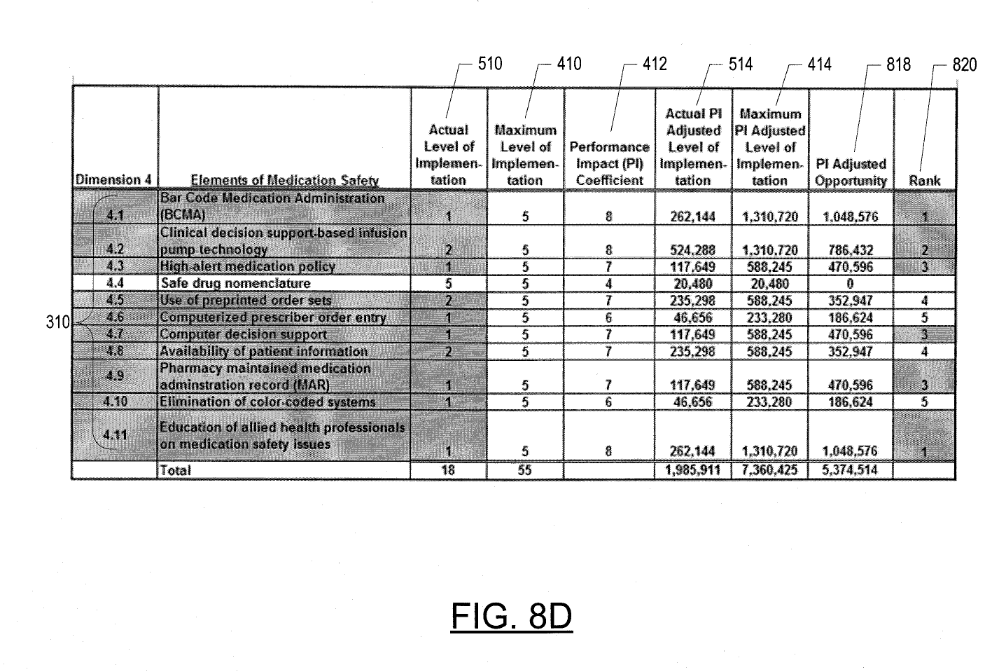

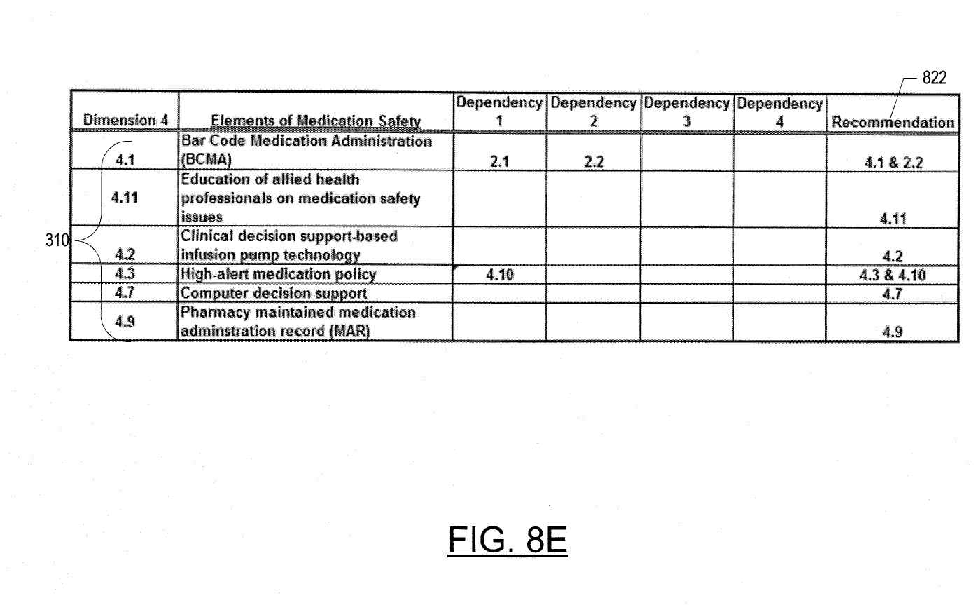

The following FIGS. 8A through 8E illustrate an enhanced assessment tool of one embodiment, which may be offered in order to not only provide a pharmacy with an evaluation of their current implementation of various performance measures, as described above, but further to provide them with a recommendation of on which performance measures to focus, and in what order, in order to see the greatest return with the least expended time and effort.

Referring to FIG. 8A, using the information described above in relation to each of the areas or dimensions (i.e., subsets of performance measures), the assessment server (e.g., processor or similar means operating thereon) may determine which of the areas or dimensions has the greatest remaining opportunity for improvement or increased implementation. In order to make this determination, the assessment server (e.g., processor or similar means) may first determine the Performance Impact Adjusted Opportunity 810 associated with each area or dimension, wherein

PI Adjusted Opportunity=Maximum PI Adjusted Level of Implementation−Actual PI Adjusted Level of Implementation

The Remaining Opportunity 812 associated with each area or dimension may then be calculated by dividing the Performance Impact Adjusted Opportunity 810 of each dimension by the total Performance Impact Adjusted Opportunity:

Remaining Opportunity=Actual PI Adjusted Level of Implementation/Σ Actual PI Adjusted Level of Implementation of all Dimensions

The Remaining Opportunity indicates which dimension represents the greatest opportunity with respect to the other dimension. As shown in the example illustrated in FIGS. 8A and 8B, the dimension having the greatest Remaining Opportunity 812 based on the Actual Level of Implementation and the performance impact associated with implementation of the corresponding elements is dimension 4 (i.e., medication safety), having a Remaining Opportunity 812 of 28.56%.

For the dimension (or subset of performance measures) identified as having the highest Remaining Opportunity 812, the assessment server (e.g., processor or similar means operating on the assessment server) may determine the Performance Impact Adjusted Opportunity 818 associated with each element (or performance measure) of that dimension (or subset of performance measures). (See FIG. 8C). As above with respect to the Performance Impact Adjusted Opportunity associated with the area or dimension, the Performance Impact Adjusted Opportunity 818 of the element may be calculated by subtracting the Actual Performance Impact Adjusted Level of Implementation 514 of the element from the Maximum Performance Impact Adjusted Level of Implementation 414 of the element.

According to one embodiment, the assessment server, or processor or similar means operating on the assessment server, may then identify those elements (or performance measures) of the dimension (or subset of performance measures) having more than a nominal amount of room for additional implementation, and then rank those elements (or performance measures) from the largest Performance Impact Adjusted Opportunity 818 to the smallest. For example, in one embodiment, the assessment server (e.g., processor or similar means) may identify those elements (or performance measures) having an Actual Level of Implementation 510 that is less than four, and then ranking those elements (or performance measures) from the largest Performance Impact Adjusted Opportunity 818 to the smallest. Once the elements (or performance measures) have been ranked, the assessment server (e.g., processor or similar means) of one embodiment may identify those elements having a ranking of a 1, 2 or 3. For example, in the illustrated example of FIG. 8D, the following elements would be included in the elements identified: 4.1, 4.2, 4.3, 4.7, 4.9 and 4.11.

Next, as shown in FIG. 8E, according to one embodiment, the interdependencies associated with each of the ranked elements (or performance measures) 310, as well as the Actual Level of Implementation 510 of those interdependent elements may be determined (e.g., by reviewing previously input information). If the Actual Level of Implementation of the interdependent performance measure or element is less than four, indicating that more than a nominal amount of additional implementation may be performed, the interdependent performance measure may be included with the original element or performance measure in a recommendation of next steps for the pharmacy to implement. Otherwise (i.e., if the interdependent element has an Actual Level of Implementation of equal to or greater than four), then the interdependent element or performance measure is not included, since it is assumed that the pharmacy is already implementing the performance measure or element either usually or all of the time.

For example, as discussed above and shown in FIG. 8E, elements 4.1, 4.2, 4.3. 4.7. 4.9 and 4.11 were identified as having an Actual Level of Implementation less than four. Of those, elements 4.1 and 4.3 have interdependent elements or performance measures. In particular, implementation of element 4.1 may depend, to some extent, on the implementation of elements 2.1 and 2.2, while implementation of element 4.3 may depend, to some extent, on the implementation of element 4.10. Of the interdependent elements, only element 2.1 has an Actual Level of Implementation that is greater than or equal to four (as shown in FIG. 5). As a result, according to one embodiment, the recommendation provided to pharmacy may include not only the elements of dimension 4 identified and ranked (i.e., 4.1, 4.2, 4.3, 4.7, 4.9 and 4.11), but also interdependent elements 2.2 and 4.10.

As noted above, the foregoing is provided for exemplary purposes only and should not be taken as limiting embodiments of the invention in any way. While embodiments of the invention may each involve receiving a set of performance measures, assigning a performance impact to those performance measures, and evaluating an overall performance based on the assigned performance impact and a current level of implementation, as one of ordinary skill in the art will recognize, various aspects of the embodiments described above may differ from embodiment to embodiment. For example, the performance measures received may differ from one embodiment to the next, the use of subsets (e.g., areas or dimensions) associated with the performance measures may or may not be used in various embodiments, and the performance impact and feasibility parameters assigned may differ from embodiment to embodiment.

### Benchmarking Method:

Reference is now made to FIG. 9, which illustrates the operations that may be taken in order to provide yet another tool for assessing or evaluating the performance of a pharmacy, or similar institution or entity. As shown, this process may begin, at Block 901, when the assessment server (which may or may not be the same server as discussed above), and in particular the processor or similar means operating on the assessment server, defines a plurality of parameters that can be used to characterize a pharmacy, or similar institution. Where the assessment tool may be used for evaluating pharmacies, these parameters may include, for example, the facility type (e.g., short term acute, long term care, heart hospital, psychiatric hospital, military short term, military long term, pediatric, etc.) the technology used by the pharmacy (e.g., Robot-Rx®, Intellishelf-Rx®, manual prescription fulfillment, etc.), the services supported (e.g., chemo, dedicated psychiatric unit, transplants, dialysis, etc.), the outsourced services (e.g., TPNs, packaging, etc.) whether the pharmacy uses a centralized or decentralized medication distribution model, or the like.

Once these parameters have been defined, the assessment server (e.g., processor or similar means operating thereon) may receive, at Block 902, a value or definition for some or all of these parameters from a pharmacy, or similar institution and, in particular, from an electronic device 100, 110 (e.g., personal computer or computer workstation) operated by personnel of the pharmacy, or similar institution, via a network 120. The assessment server may further receive, at Block 903, an indication of which of the parameters the pharmacy would like to be used for comparing the pharmacy with other pharmacies, as well as specifically how those parameters should be used.

For example, according to one embodiment, the pharmacy may indicate that it would like to focus on the centralized vs. decentralized parameter. The pharmacy may further indicate that it would like to be compared to other pharmacies having every other parameter defined in a similar manner as the requesting pharmacy (i.e., having substantially the same profile as the requesting pharmacy), except the centralized vs. decentralized parameter. In other words, for example, assuming the requesting pharmacy uses a centralized medication distribution model, the requesting pharmacy may desire to be compared to other pharmacies having the same or similar facility type and technology, supporting the same or similar services, and outsourcing the same or similar services, yet using a decentralized medication distribution model.

As another example, a pharmacy may indicate that it would like to focus on the use of a Robot-Rx® as an automated medication dispensing device. In particular, a pharmacy that does not use a Robot-Rx® automated medication dispensing device may indicate that it would like to be compared to other pharmacies having the same or similar profile (e.g., same or similar facility type and technology, supporting the same or similar services, etc.) except that they do have a Robot-Rx® automated medication dispensing device.

By enabling the pharmacy, or similar institution, to specifically define the makeup of the group of pharmacies, or similar institutions, with which it will be compared, the assessment tool of embodiments of the present invention enables the pharmacy, or similar institution, to manipulate the assessment or evaluation it would like to receive. In particular, according to one embodiment, a pharmacy may be able to specifically identify the benefits and/or costs associated with the implementation or usage of one or more specific parameters. To illustrate, in the example above wherein the requesting pharmacy desires to be compared to all pharmacies using a decentralized medication distribution model or having a Robot-Rx® automated medication dispensing device, but otherwise having a substantially identical profile, the requesting pharmacy is able to readily see the influence using a centralized (or decentralized) medication distribution model or a Robot-Rx® automated medication dispensing device has on the performance of the pharmacy in various areas. This information may be used by pharmacy personnel to justify the pharmacy's current implementation (or non-implementation) of various parameters, as well as to provide support for implementing a new or different parameter (e.g., acquiring a Robot-Rx® automated medication dispensing device).

Using the information received from the pharmacy (i.e., the electronic device operated by pharmacy personnel), as well as information received from other pharmacies defining or providing values for their corresponding parameters, the assessment server (e.g., the processor or similar means operating on the assessment server) may then assemble the group of pharmacies, or similar institutions, with which to compare the requesting pharmacy. (Block 904).

At Block 905, the assessment server (e.g., processor or similar means) may receive raw data from the requesting pharmacy (e.g., from an electronic device 100, 110 operating at the pharmacy via a secure web-based portal). This data may be gathered, for example, from the pharmacy's Pharmacy Information System, Hospital Information Systems, HR Information Systems, and/or the like, and may include, for example the number of pharmacists, technicians and administrative staff employed, the number of hours the pharmacy was open in a specific month, the number of pharmacist, technician and administrative staff hours worked for a specific month, the number and type of medications dispensed, what those medications are, patient length of stay data (including adjusted patient days and adjusted patient discharge data), and the like. Using the data gathered, the assessment server (e.g., processor or similar means operating thereon) may generate a plurality of metrics associated with the pharmacy (Block 906) that can thereafter be used in comparing the requesting pharmacy to the pharmacies of the assembled group (Block 907).

In particular, according to one embodiment, the assessment server (e.g., processor or similar means operating thereon) may standardize the raw data received across all pharmacies, or similar institutions, from which similar raw data has been received. Calculations may then be performed on the standardized data to derive various metrics. Where, for example, the institutions being compared are pharmacies, the metrics may include, for example, the number of doses dispensed per pharmacist, technician and/or total pharmacy hour, staffing/day and workload (by job type), staffing ratios (e.g., pharmacist to technician, etc.), workload/day, turnaround time, chemo orders/day/pharmacists, interventions/pharmacist/day, % pre-made solutions, % CPOE orders, drug cost/day, drug cost/discharge, non-formulary %, pharmacy drug expense as % of total drug expense, savings from substitutions, purchases vs. dispenses, and the like. The pharmacy can then use these metrics to compare itself to the pharmacies of the assembled group.

According to one embodiment, a pharmacy, or similar institution, is further able to use the metrics to drill into their data in order to understand the root causes of any differences or similarities seen between the requesting pharmacy, or similar institution, and the pharmacies, or similar institutions, with which it was compared. For example, if an institution discovered, using an assessment tool of embodiments of the invention, that its length of stay metric was significantly longer than the length of stay of the other institutions, the institution may be able to drill into the length of stay metric to determine what may be causing this disparity. For example, the length of stay metric may be broken down into the length of stay per hospital admission type (e.g., heart patient, orthopedic patient, OBGYN patient, neurology patient, etc.). If after doing that, it appears that the length of stay for neurology patients is significantly longer than that of other types of patients, the metric may be further drilled down to view the length of stay per attending physician. This may indicate that Dr. X has a significantly longer length of stay associated with him or her, than Dr. Y. Using this information, the institution can approach Drs. X and Y to discuss what can be done in order to reduce the length of stay associated with Dr. Y, and thereby to improve the institution's performance in relation to the institutions with which it was compared.

While as described above, the method and apparatus of this embodiment is well suited for quantifying the performance differential provided by the change in a single parameter (e.g., centralized vs. decentralized medication dispensing model, etc.), other embodiments of the method and apparatus could evaluate the performance differential occasioned by entities differing by two or more particular parameters while still being the same in regards to the other parameters. This might be useful if a pharmacy was considering several alternative renovation projects, each of which potentially changing several different parameters, or if several parameters are interrelated (e.g., the addition of Robot-Rx® automated medication dispensing device may dictate movement from a decentralized to a centralized medication dispensing model).

### Conclusion:

As described above and as will be appreciated by one skilled in the art, embodiments of the present invention may be configured as a method or apparatus. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processor 131 discussed above with reference to FIG. 1B, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus (e.g., processor 131 of FIG. 1B) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
receiving a definition of a set of performance measures;
assigning a performance impact parameter to respective performance measures, said performance impact parameter based at least in part on a projected return associated with implementation of the performance measure;
receiving an indication of a current level of implementation associated with respective performance measures; and
evaluating an overall performance based at least in part on the current level of implementation and the performance impact parameter associated with respective performance measures.

2. The method of claim 1, wherein evaluating an overall performance further comprises:
generating a recommendation comprising a prioritized list of one or more performance measures for additional implementation based at least in part on the current level of implementation and the performance impact parameter associated with respective performance measures.

3. The method of claim 2 further comprising:
assigning a feasibility parameter to respective performance measures, said feasibility parameter based at least in part on a cost associated with implementation of the performance measure, wherein the prioritized list of one or more performance measures for additional implementation is further based at least in part on the feasibility parameter associated with respective performance measures.

4. The method of claim 2 further comprising:
identifying one or more interdependencies associated with one or more performance measures of the set of performance measures, wherein the prioritized list of one or more performance measures for additional implementation is further based at least in part on the one or more interdependencies identified.

5. The method of claim 1, wherein the set of performance measures comprises one or more subsets of performance measures and wherein evaluating an overall performance further comprises:
determining a current level of implementation associated with respective subsets of performance measures;
determining an overall performance impact parameter associated with respective subsets; and
identifying at least one of the subsets having the greatest opportunity associated therewith based at least in part on the current level of implementation and the overall performance impact associated with respective subsets.

6. An apparatus comprising:
a processor configured to:
receive a definition of a set of performance measures;
assign a performance impact parameter to respective performance measures, said performance impact parameter based at least in part on a projected return associated with implementation of the performance measure;
receive an indication of a current level of implementation associated with respective performance measures; and
evaluate an overall performance based at least in part on the current level of implementation and the performance impact parameter associated with respective performance measures.

7. The apparatus of claim 6, wherein in order to evaluate an overall performance, the processor is further configured to:
generate a recommendation comprising a prioritized list of one or more performance measures for additional implementation based at least in part on the current level of implementation and the performance impact parameter associated with respective performance measures.

8. The apparatus of claim 7, wherein the processor is further configured to:
assign a feasibility parameter to respective performance measures, said feasibility parameter based at least in part on a cost associated with implementation of the performance measure, wherein the prioritized list of one or more performance measures for additional implementation is further based at least in part on the feasibility parameter associated with respective performance measures.

9. The apparatus of claim 7, wherein the processor is further configured to:
identify one or more interdependencies associated with one or more performance measures of the set of performance measures, wherein the prioritized list of one or more performance measures for additional implementation is further based at least in part on the one or more interdependencies identified.

10. The apparatus of claim 6, wherein the set of performance measures comprises one or more subsets of performance measures and wherein in order to evaluate an overall performance, the processor is further configured to:
determine a current level of implementation associated with respective subsets of performance measures;
determine an overall performance impact parameter associated with respective subsets; and
identify at least one of the subsets having the greatest opportunity associated therewith based at least in part on the current level of implementation and the overall performance impact associated with respective subsets.

11. A computer program product comprising at least one computer-readable storage medium having computer-readable program code portions stored therein, the computer-readable program code portions comprising:
a first executable portion for receiving a definition of a set of performance measures;
a second executable portion for assigning a performance impact parameter to respective performance measures, said performance impact parameter based at least in part on a projected return associated with implementation of the performance measure;
a third executable portion for receiving an indication of a current level of implementation associated with respective performance measures; and
a fourth executable portion for evaluating an overall performance based at least in part on the current level of implementation and the performance impact parameter associated with respective performance measures.

12. The computer program product of claim 11, wherein the fourth executable portion is further configured to:
generate a recommendation comprising a prioritized list of one or more performance measures for additional implementation based at least in part on the current level of implementation and the performance impact parameter associated with respective performance measures.

13. The computer program product of claim 12, wherein the computer-readable program code portions further comprise:
a fifth executable portion for assigning a feasibility parameter to respective performance measures, said feasibility parameter based at least in part on a cost associated with implementation of the performance measure, wherein the prioritized list of one or more performance measures for additional implementation is further based at least in part on the feasibility parameter associated with respective performance measures.

14. The computer program product of claim 12, wherein the computer-readable program code portions further comprise:
a fifth executable portion for identifying one or more interdependencies associated with one or more performance measures of the set of performance measures, wherein the prioritized list of one or more performance measures for additional implementation is further based at least in part on the one or more interdependencies identified.

15. The computer program product of claim 11, wherein the set of performance measures comprises one or more subsets of performance measures and wherein the fourth executable portion is further configured to:
determine a current level of implementation associated with respective subsets of performance measures;
determine an overall performance impact parameter associated with respective subsets; and
identify at least one of the subsets having the greatest opportunity associated therewith based at least in part on the current level of implementation and the overall performance impact associated with respective subsets.

16. A method comprising:
receiving a value for at least two of a plurality of parameters associated with a first entity;
receiving an indication of one or more of the plurality of parameters to be used in creating a group of one or more entities with which to compare the first entity; and
assembling the group of one or more entities by identifying one or more entities having a value for respective one or more indicated parameters that is different than the value received from the first entity in association with the respective one or more indicated parameters and a value for a remaining one or more of the plurality of parameters not indicated that is the same as the value received from the first entity in association with the respective one or more remaining parameters.

17. The method of claim 16 further comprising:
receiving data associated with the first entity;
generating one or more metrics associated with the first entity based at least in part on the data received; and
comparing the first entity to the one or entities of the assembled group based at least in part on the one or more metrics generated.

18. The method of claim 17, wherein the first entity comprises a pharmacy.

19. The method of claim 18, wherein one of the one or more indicated parameters comprises whether the pharmacy whether uses a centralized or decentralized medication distribution model.

20. The method of claim 18, wherein one of the one or more indicated parameters comprises whether the pharmacy uses an automated medication storage and dispensing device.

21. An apparatus comprising:
a processor configured to:
receive a value for at least two of a plurality of parameters associated with a first entity;
receive an indication of one or more of the plurality of parameters to be used in creating a group of one or more entities with which to compare the first entity; and
assemble the group of one or more entities by identifying one or more entities having a value for respective one or more indicated parameters that is different than the value received from the first entity in association with the respective one or more indicated parameters and a value for a remaining one or more of the plurality of parameters not indicated that is the same as the value received from the first entity in association with the respective one or more remaining parameters.

22. The apparatus of claim 21, wherein the processor is further configured to:
receive data associated with the first entity;
generate one or more metrics associated with the first entity based at least in part on the data received; and
compare the first entity to the one or entities of the assembled group based at least in part on the one or more metrics generated.

23. The apparatus of claim 22, wherein the first entity comprises a pharmacy.

24. The apparatus of claim 23, wherein one of the one or more indicated parameters comprises whether the pharmacy whether uses a centralized or decentralized medication distribution model.

25. The apparatus of claim 23, wherein one of the one or more indicated parameters comprises whether the pharmacy uses an automated medication storage and dispensing device.
